(19) United States
(12) Patent Application Publication
(10) Pub. No.: US 2014/0245195 A1
(43) Pub. Date: Aug. 28, 2014

(54) DUPLICATING GRAPHICAL WIDGETS

(71) Applicant: INTERNATIONAL BUSINESS MACHINES CORPORATION, Armonk, NY (US)

(72) Inventor: John E. Swanke, Terryville, CT (US)

(73) Assignee: International Business Machines Corporation, Armonk, NY (US)

(21) Appl. No.: 13/775,429

(22) Filed: Feb. 25, 2013

(51) Int. Cl. G06F 3/048

(52) U.S. Cl. CPC G06F 3/048
USPC 715/762

(57) ABSTRACT

A method, computer program product, and system is described. A depiction of a duplication handle associated with a graphical widget is provided. A selection of the duplication handle is identified. A selection of a duplication region associated with the selection of the duplication handle is identified. One or more duplicate widgets associated with the graphical widget and the duplication region are provided.

### TECHNICAL FIELD

This disclosure relates to graphical editors.

### BACKGROUND

Graphical editors (or “editors”) may facilitate the creation and/or editing of various models and representations, with graphical widgets (i.e., graphical items forming part of a representation or model) and widget connectors (i.e., representations, such as lines of various configurations, of connections and/or associations between various widgets) representing various aspects of a particular model or representation. For example, graphical editors may facilitate the representation of a flow process, a mechanism, an algorithm, an organizational structure, and so on through the arrangement of various graphical widgets (e.g., various shapes or objects) and various widget connectors (e.g., various lines connecting or otherwise associating various widgets with each other). Graphical editors may be implemented in various ways, such as through desktop, mobile (or other) applications and/or web applications running within a browser (itself operating, for example, on a desktop computer or mobile computing device such as a cellular pone or tablet device). Editors may sometimes provide a standard set of widgets that can be added to a relevant representation or diagram through the use of an editor tool and/or various user actions. In certain instances, editors may facilitate customization of various aspects of a widget (and/or widget connector), including the widget name, appearance (e.g., color, size, shape, and so on), and/or various other semantic, visual, or other properties. Such customizations may or may not be visible in various editing/viewing modes associated with the graphical editor (or another application).

### BRIEF SUMMARY OF THE DISCLOSURE

According to one aspect of the disclosure, a computer-implemented method includes providing, by one or more computing devices, a depiction of a duplication handle associated with a graphical widget. The method includes identifying, by the one or more computing devices, a selection of the duplication handle. The method includes identifying, by the one or more computing devices, a selection of a duplication region associated with the selection of the duplication handle. The method includes providing, by the one or more computing devices, one or more duplicate widgets associated with the graphical widget and the duplication region.

One or more of the following features may be included. The depiction of the duplication handle may be provided based upon, at least in part, identifying the graphical widget as an active widget. The duplication handle may be depicted as semi-transparent. The method may include providing a depiction of the duplication region based upon, at least in part, the selection of the duplication region. The method may include providing a preview of the one or more duplicate widgets based upon, at least in part, the selection of the duplication region. The method may include identifying a widget connector associated with the graphical widget and a source widget. The method may include providing one or more duplicate widget connectors associated with the one or more duplicate widgets and the source widget. The one or more duplicate widgets may be provided in a grid arrangement. The one or more duplicate widget connectors may be provided only with respect to one or more of a single row of the grid and a single column of the grid. The method may include providing spacing between the one or more duplicate widgets based upon, at least in part, a size factor associated with the graphical widget.

According to another aspect of the disclosure, a computer program product resides on a computer readable storage medium that has a plurality of instructions stored on it. When executed by a processor, the instructions cause a processor to perform operations including providing a depiction of a duplication handle associated with a graphical widget. The operations identifying a selection of the duplication handle. The operations include identifying a selection of a duplication region associated with the selection of the duplication handle. The operations include providing one or more duplicate widgets associated with the graphical widget and the duplication region.

One or more of the following features may be included. The depiction of the duplication handle may be provided based upon, at least in part, identifying the graphical widget as an active widget. The duplication handle may be depicted as semi-transparent. The operations may include providing a depiction of the duplication region based upon, at least in part, the selection of the duplication region. The operations may include providing a preview of the one or more duplicate widgets based upon, at least in part, the selection of the duplication region. The operations may include identifying a widget connector associated with the graphical widget and a source widget. The operations may include providing one or more duplicate widget connectors associated with the one or more duplicate widgets and the source widget. The one or more duplicate widgets may be provided in a grid arrangement. The one or more duplicate widget connectors may be provided only with respect to one or more of a single row of the grid and a single column of the grid. The operations may include providing spacing between the one or more duplicate widgets based upon, at least in part, a size factor associated with the graphical widget.

According to another aspect of the disclosure, a computing system includes one or more processor devices and one or more memory architectures coupled with the one or more processor devices. The one or more processor devices are configured to provide a depiction of a duplication handle associated with a graphical widget. The one or more processor devices are configured to identify a selection of the duplication handle. The one or more processor devices are configured to identify a selection of a duplication region associated with the selection of the duplication handle. The one or more processor devices are configured to provide one or more duplicate widgets associated with the graphical widget and the duplication region.

One or more of the following features may be included. The depiction of the duplication handle may be provided based upon, at least in part, identifying the graphical widget as an active widget. The duplication handle may be depicted as semi-transparent. The one or more processor devices may be configured to provide a depiction of the duplication region based upon, at least in part, the selection of the duplication region. The one or more processor devices may be configured to provide a preview of the one or more duplicate widgets based upon, at least in part, the selection of the duplication region. The one or more processor devices may be configured to identify a widget connector associated with the graphical widget and a source widget. The one or more processor devices may be configured to provide one or more duplicate widget connectors associated with the one or more duplicate widgets and the source widget. The one or more duplicate widgets may be provided in a grid arrangement. The one or more duplicate widget connectors may be provided only with respect to one or more of a single row of the grid and a single column of the grid. The one or more processor devices may be configured to provide spacing between the one or more duplicate widgets based upon, at least in part, a size factor associated with the graphical widget.

According to another aspect of the disclosure, a computer-implemented method includes providing, by one or more computing devices, a depiction of a duplication handle associated with a graphical widget. The method includes identifying, by the one or more computing devices, a selection of the duplication handle. The method includes identifying, by the one or more computing devices, a selection of a duplication region associated with the selection of the duplication handle. The method includes providing a preview of one or more duplicate widgets associated with the graphical widget and the duplication region based upon, at least in part, the selection of the duplication region. The method includes providing, by the one or more computing devices, the one or more duplicate widgets associated with the graphical widget and the duplication region.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a widget duplication process coupled to a distributed computing network;

FIG. 2 is a flowchart of a process executed by the widget duplication process of FIG. 1;

FIG. 3 is a diagrammatic view of an aspect of the widget duplication process of FIG. 1.

FIG. 4 is a diagrammatic view of an aspect of the widget duplication process of FIG. 1.

FIG. 5 is a diagrammatic view of an aspect of the widget duplication process of FIG. 1.

FIG. 6 is a diagrammatic view of an aspect of the widget duplication process of FIG. 1.

Like reference symbols in the various drawings indicate like elements.

### DETAILED DESCRIPTION OF THE PREFERRED EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Graphical editor (“GE”) applications may facilitate the creation and/or editing of various models and representations, with graphical widgets (i.e., graphical items forming part of a representation or model) and widget connectors (i.e., representations, such as lines of various configurations, of connections and/or associations between various widgets) representing the various aspects of a particular model or representation. (As used herein, it will be understood that the term “widget” may be used in order to refer to a “graphical widget” and the term “connector” may be used in order to refer to a “widget connector.”) For example, GE applications may facilitate the representation of a flow process, a mechanism, an algorithm, an organizational structure, and so on through the arrangement and configuration of various graphical widgets (e.g., various shapes or objects) and various widget connectors (e.g., various lines connecting or otherwise associating various widgets with each other). For example, in certain embodiments, GE applications may facilitate modeling of software code architecture using graphical widgets and widget connectors. In certain embodiments, such graphical models may be converted by a GE application (and/or another application) into functional software code. For example, a GE application may be utilized to generate the code for a user interface based on the configuration and properties of various graphical widgets included in a model that is created and/or edited in the GE application.

Graphical widgets and/or widget connectors may be arranged and/or configured in various ways. In certain embodiments, for example, GE applications may facilitate user entry of various properties for one or more graphical widgets or widget connectors. Widget and/or connector properties may include properties that are visually represented in a depiction of the widget/connector (e.g., size, shape, location, orientation, title, and other visible properties) and/or may include properties that are not visually represented in a depiction of the widget/connector (e.g., functional properties and settings).

Once a widget has been created (and/or customized) within a graphical editor a user may desire to duplicate the widget within the editor. In certain implementations of a graphical editor, this may be possible by (1) selecting the widget and using a “copy”/“cut” and “paste” action (e.g., via a keyboard input) or (2) selecting the widget and utilizing a “duplicate” action that creates a duplicate widget (e.g., via a GE application tool). These duplication methods may be unsatisfactory, for example, in that they (1) may require excessive mouse clicks (or analogous actions, such as keyboard inputs), (2) may require specific menu and/or control keys, which may not be present in a particular embodiment of a GE application (e.g., an editor running on a browser or touch device), and (3) may result in imprecise, random, and/or otherwise undesirable placement of the duplicated widget (e.g., which may increase the number of necessary mouse clicks or analogous actions to appropriately locate the duplicate widget). A widget duplication (“WD”) process (or application) may address these and/or various other issues by, for example, facilitating rapid, precise, and easy duplication of widgets and/or widget connectors through the utilization of duplication handles and duplication regions.

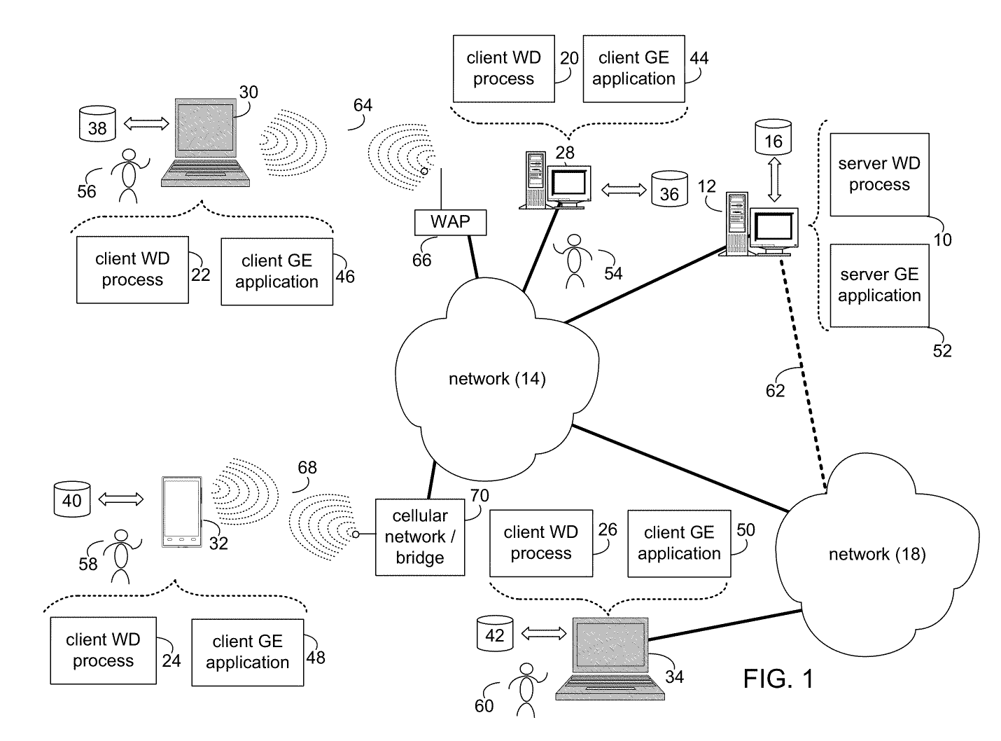

Referring now to FIG. 1, a WD process may be coupled to a computer or computer network. For example, server WD process 10 may reside on and may be executed by server computer 12, which may be connected to network 14 (e.g., the Internet or a local area network). Examples of server computer 12 may include, but are not limited to: a personal computer, a server computer, a series of server computers, a mini computer, and/or a mainframe computer. Server computer 12 may be a web server (or a series of servers) running a network operating system, examples of which may include but are not limited to: Microsoft® Windows Server®; Novell® Netware®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

The instruction sets and subroutines of server WD process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft® IIS, Novell® Web Server™, or Apache® Web Server, that allows for access to server computer 12 (via network 14) using one or more protocols, examples of which may include but are not limited to HTTP (i.e., HyperText Transfer Protocol), SIP (i.e., session initiation protocol), and the Lotus® Sametime® VP protocol. (Webserver is a trademark of Novell Corporation in the United States, other countries, or both; Apache is a registered trademarks of Apache Software Foundation in the United States, other countries, or both; Lotus and Sametime are registered trademarks of International Business Machine Corp. in the United States, other countries, or both.) Network 14 may be connected to one or more secondary networks (e.g., network 18), examples of which may include but are not limited to: a local area network; a wide area network; or an intranet, for example.

Client WD processes 20, 22, 24, 26 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 14 and/or network 18 and may each execute an operating system, examples of which may include but are not limited to Microsoft® Windows®, Microsoft Windows CE®, Red Hat® Linux®, or a custom operating system.

The instruction sets and subroutines of client WD processes 20, 22, 24, 26, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

In an embodiment, the WD process may be a server-side process (e.g., which may be implemented via server WD process 10), in which all of the functionality of the WD process may be executed on a server computer (e.g., server computer 12). In an embodiment, the WD process may be a client-side process (e.g., which may be implemented via one or more of client WD processes 20, 22, 24, 26), in which all of the functionality of the WD process may be executed on a client computing device (e.g., one or more of client electronic devices 28, 30, 32, 34). In an embodiment, the WD process may be a hybrid server-client process (e.g., which may be implemented by server WD process 10 and one or more of client WD processes 20, 22, 24, 26), in which at least a portion of the functionality of the WD process may be implemented via server computer 12 and at least a portion of the functionality of the WD process may be implemented via one or more client computing devices (e.g., one or more of client electronic devices 28, 30, 32, 34).

In certain embodiments, a WD process may be a stand-alone process. In certain embodiments, a WD process may operate as part of, or in conjunction with, one or more other processes and/or may include one or more other processes. For example, in certain embodiments, a WD process may be included in (or may operate in conjunction with) a graphical editor (“GE”) application (or process.

A GE application (or process) may facilitate the creation and/or editing of various models and representations, through the use of graphical widgets and/or widget connectors. For example, a GE application may facilitate creation and/or editing of various graphical models or representations. A GE application may facilitate the representation, for example, of flow processes, mechanisms, algorithms, organizational structures, and so on, through the arrangement of various graphical widgets (e.g., various shapes or objects), various widget connectors (e.g., various lines connecting or otherwise associating various widgets with each other), and/or a variety of other visual (and/or other) objects. In certain embodiments, a GE application may include (and/or may access) a library of standard (or other) widgets and connectors, which may be useful in creating and/or editing various types of representations or diagrams.

A GE application (or process) may operate (and/or reside) on a client device (e.g., client GE application 44, operating on client electronic device 28; client GE application 46, operating on client electronic device 30; client GE application 48, operating on client electronic device 32; or client GE application 50, operating on client electronic device 34). A client WD process (e.g., client WD process 20) or a server WD process (e.g., server WD process 10) may be in communication with a client GE application (e.g., client GE application 44) or may be part of a client GE application.

A GE application may additionally/alternatively operate (and/or reside) on a server device (e.g., server GE application 52, operating on server computer 12 or another server GE application (not shown), operating on another server computer (not shown)). A server WD process (e.g., server WD process 10) or a client WD process (e.g., client WD process 20) may be in communication with a server GE application (e.g., server GE application 52) or may be a part of a server GE application.

Users 54, 56, 58, 60 may access a WD process in various ways. For example, these users may access server WD process 10 directly through the device on which a client process (e.g., client WD processes 20, 22, 24, 26) is executed, namely client electronic devices 28, 30, 32, 34. Users 54, 56, 58, 60 may access server WD process 10 directly through network 14 and/or through secondary network 18. Further, server computer 12 (i.e., the computer that executes server WD process 10) may be connected to network 14 through secondary network 18, as illustrated with phantom link line 62. Users 54, 56, 58, 60 may also access a client or server GE application (or process) in similar ways.

The various client electronic devices may be directly or indirectly coupled to network 14 (or network 18). For example, personal computer 28 is shown directly coupled to network 14 via a hardwired network connection. Further, notebook computer 34 is shown directly coupled to secondary network 18 via a hardwired network connection. Laptop computer 30 is shown wirelessly coupled to network 14 via wireless communication channel 64 established between laptop computer 30 and wireless access point (“WAP”) 66, which is shown directly coupled to network 14. WAP 66 may be, for example, an IEEE 802.11a, 802.11b, 802.11g, 802.11n, Wi-Fi, and/or Bluetooth device that is capable of establishing wireless communication channel 64 between laptop computer 30 and WAP 66. Data-enabled mobile telephone 32 is shown wirelessly coupled to network 14 via wireless communication channel 68 established between data-enabled mobile telephone 32 and cellular network/bridge 70, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

For the following discussion, client WD process 20 will be described for illustrative purposes. It will be understood that client WD process 20 may, for example, interact and/or communicate with a server WD process such as server WD process 10 and/or may be executed within one or more applications that allow for communication with other server and/or client WD processes. This is not intended to be a limitation of this disclosure, as other configurations are possible (e.g., WD process 20 may include stand-alone client processes and/or stand-alone server processes). For example, some implementations may include one or more of client WD processes 22, 24, 26 or server WD process 10 in place of or in addition to client WD process 20.

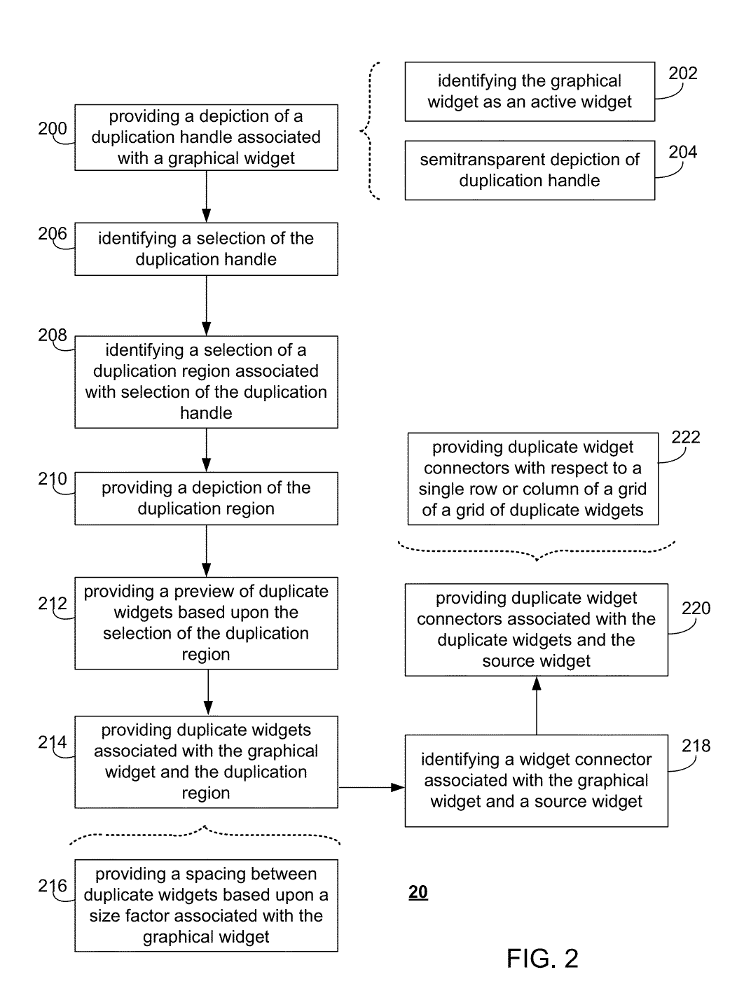

Referring now also to FIG. 2, there is shown a diagrammatic view of an example process that may be implemented by a WD process, e.g., client WD process 20. Client WD process 20 may provide 200 a depiction of a duplication handle associated with a graphical widget (and/or widget connector). As also noted above, graphical widgets may be graphical items forming part of a representation or model in a GE application. For example, with respect to a user interface model, a widget may be a button, a menu bar, a shape, a clock, a calendar, a tree, a selector (e.g., a font or file selector) and so on. Similarly, with respect to a model of software code, a widget may be a graphical representation of a particular functionality, information flow, data storage device or operation, logical element, algorithmic step and so on. A handle may be a graphical element, which may be associated with a particular widget, widget connector and/or other graphical representation, and which may facilitate implementation of various functionality with respect to the particular widget, connector, and/or graphical representation. For example, a “move” handle may be a graphical element, selection of which (e.g., by mouse-click or touch-screen gesture) may facilitate moving an associated widget. Similarly, a “resize” handle may be a graphical element, selection of which may facilitate resizing an associated widget. Accordingly, a duplication handle may be a handle that facilitates duplication of an associated widget. A duplication handle may take a variety of forms and may include a variety of features and, in certain embodiments, may be associated with and/or coincident with one or more other handles (e.g., a resize handle). In certain embodiments, a duplication handle may be depicted as an icon, animation, or other representation at or near an edge of an associated widget (or other GE application element).

In certain embodiments, a depiction of a duplication handle may be provided 200 based upon identifying 202 the graphical widget as an active widget. Similarly, in certain embodiments a depiction of a duplication handle may not be provided with respect to a particular graphical widget if that widget is not an active widget. For example, in certain embodiments a duplication handle associated with a particular widget (and/or widget connector) may not be visible to a user of a GE application until the user selects the associated widget (e.g., by clicking on the widget, by moving a mouse cursor over the widget, by selecting the widget using a touch-screen gesture, and so on). Similarly, in certain embodiments, a duplication handle may be made visible by WD process 20 with respect to a widget identified by WD process 20 (and/or a GE or other application) as pertinent to a current activity associated with the GE application (e.g., based on identification of an error or other issue associated with the widget).

In certain embodiments, duplication handles associated with inactive widgets may be depicted, but in a less prominent manner than duplication handles associated with active widgets (e.g., in a transparent or more transparent manner, in a more muted color, in a “grayed-out” state, and so on). In certain embodiments, multiple widgets may be treated by WD process 20 as “active” at any given time (e.g., based upon concurrent selection of multiple widgets by a user, based upon selection of various widgets within a recent timeframe, and so on).

In certain embodiments, WD process 20 may provide 200 a depiction of a duplication handle in such a way as to avoid obscuring other relevant aspects of an associated (and/or other) widget. For example, in certain embodiments, WD process 20 may provide 200 a depiction of a duplication handle that is located (and/or otherwise presented) so as not to obscure other functionality or features (e.g., a “resize” handle, a “move” handle, a widget title, a widget properties menu, and so on). In certain embodiments, WD process 20 may provide 200 semitransparent depiction 204 of a duplication handle. As used herein, “semitransparent” may refer to a depiction that allows a user to view aspects of both the item depicted (e.g., a duplication handle) as well as aspects of an item that may be behind the item on a relevant display. In this way, for example, a user may perceive both the provided 200 semitransparent depiction 204 of a duplication handle as well as content, features and/or various other aspects of an associated widget that may be wholly or partially co-located with the duplication handle on a display of the relevant graphical model.

WD process 20 may identify 206 a selection of the duplication handle. For example, WD process 20 may identify 206 that a user has selected a particular duplication handle based upon a mouse-click, mouse-over, touch-screen gesture, voice command, and so on. In certain embodiments, a user may select a duplication handle by a single or double click (or equivalent touch-screen gesture) on the duplication handle (i.e., by “clicking” on the duplication handle, but not holding the mouse button for an extended amount of time). In certain embodiments, a user may select a duplication handle by clicking and holding (or equivalent touch-screen gesture) on the duplication handle (i.e., by “clicking” on the duplication handle and holding the mouse button for an extended amount of time). It will be understood that, although many examples herein will discuss user actions using a mouse device, various other similar user actions (e.g., using touch-screen gestures, voice commands, or other input mechanisms) may be utilized with respect to the various discussed functionality of WD process 20.

WD process 20 may identify 208 a selection of a duplication region associated with the identified 206 selection of the duplication handle. For example, WD process 20 may identify 208 a selection of a duplication region based upon a variety of user input and/or other information. For example, WD process 20 may identify 208 a selection of a duplication region based upon a user selecting a duplication handle with a click-and-hold action (or equivalent touch-screen gesture) and the “dragging” of the mouse cursor from the selected duplication handle to a different location on the relevant display (i.e., a “click-and-drag” action). For example, a user may click a particular duplication region then, while holding down the mouse button, may move the mouse cursor to one or more other locations on the relevant display, thereby indicating the contours of the relevant duplication region. In certain embodiments, a user may, for example, release the mouse button after these various moves of the mouse cursor in order to indicate that she has finished indicating the duplication region. Additionally/alternatively, in certain embodiments a user may simply click on a duplication handle (or engage in an equivalent touch-screen gesture), then click one or more additional times at other locations on the relevant display in order to indicate the boundaries (and/or other relevant aspects) of a particular duplication region. In some such embodiments, for example, a user may double-click the mouse (or, for example, engage in an equivalent touch-screen gesture) and/or click a second time on the relevant duplication handle in order to indicate that she has finished indicating the duplication region.

In certain embodiments, an identified 208 duplication region may be co-located (at least in part) with an associated duplication handle. For example, in the click-and-drag example discussed above, a vertex, edge or other portion of the duplication region may be located at or near the duplication handle. For example, if a user clicks-and-drags down and to the right from a duplication handle in order to define a rectangular duplication region, the duplication region may be identified 208 as having an upper-left vertex at or near the duplication handle. In certain embodiments, an identified 208 duplication region may not be co-located with an associated duplication handle. For example, in certain embodiments, clicking a duplication handle may activate a “duplication mode,” in which, for example, a user may utilize a mouse (or other input device) to designate a duplication region at a custom location (i.e., a location on the display selected and/ro indicated by the user via the mouse or other input device). (Duplication mode may then be exited, for example, by clicking the duplication handle a second time, activating an “Esc” key, and so on.) For example, a use may click a duplication handle to activate a duplication mode, then may use the mouse to designate a duplication region at a custom location (e.g., by tracing the contours of the region with the mouse cursor, designating a diagonal or diameter of a duplication region, and so on). For example, if a widget is located in the upper right corner of a display of a GE application, a user may click the duplication handle, then trace a rectangular duplication region in the lower left corner of the display.

A duplication region may take various shapes, which may depend, for example, on the manner in which the region is selected. For example, in certain embodiments, based upon a user clicking-and-dragging from a duplication handle to another point on the relevant display, WD process 20 may identify 208 the selection of a rectangular duplication region, the diagonal of which may be defined by the starting and ending point of the click-and-drag operation. In certain embodiments, based upon, for example, user preferences or other settings, a similar click-and-drag operation may additionally/alternatively inform identification 208 of the selection of a circular duplication region (e.g., with the diameter of the circle defined by the click-and-drag operation) and/or a duplication region of various other shapes. In certain embodiments, selection of a duplication region of arbitrary shape may be identified 208 based upon multiple mouse-clicks (and/or various other actions or gestures). For example, in certain embodiments, a user may define the vertices of an irregular (or other) polygon by multiple mouse-clicks, with a double-click, second click on the relevant duplication handle and/or other similar action or gesture serving to identify the final vertex (i.e., indicating the end of the selection of the duplication region).

In certain embodiments, WD process 20 may provide 210 a depiction of a duplication region. For example, based upon identifying 208 a selection of a duplication region (e.g., an in progress selection and/or a completed selection), WD process 20 may provide 210 a depiction on a relevant display of the outline of the selected duplication region. For example, WD process 20 may provide 210 a dotted-line outline of a duplication region that has been selected (or is being selected) in order to provide an indicator to a user of the size and shape of the duplication region. In certain embodiments, a provided 210 depiction of a duplication region may be updated as an identified 208 selection of the duplication region changes. For example, continuing the example above, as a user click-and-drags to select a duplication region, a continually (or otherwise) updated depiction of the duplication region (i.e., a depiction that changes to reflect the size and shape of the duplication region as the mouse cursor is relevantly moved) may be provided 210. It will be appreciated that the depiction of the depiction of the duplication region may be presented in a variety of manners in addition/as an alternative to the dotted line, for example via shading or any other suitable graphical representation.

In certain embodiments, WD process 20 may provide 212 a preview of duplicate widgets based upon the identified 208 selection of a duplication region. For example, as a user selects a duplication region (and/or after a user has selected a duplication region), WD process 20 may provide 212 a preview of duplicate widgets (i.e., widgets that duplicate an original widget associated with the duplication region) that correspond to (e.g., fit within) the duplication region. For example, a user may select a duplication handle with a mouse device and drag the mouse cursor to define a rectangular duplication region. As the user expands such a duplication region associated with a particular widget (e.g., as the user drags the mouse cursor from the duplication handle of the particular widget across the relevant display), WD process 20 may provide 212 a preview of various duplicate widgets that may fit within the duplication region. (Such preview may, for example, be provide in conjunction with providing 210 a depiction of the duplication region.) In certain embodiments, such provided 212 preview may be dynamic (e.g., may change to include more or fewer widgets as the area of he selected duplication region is increased or reduced). In certain embodiments, such a provided 212 preview may include various visual (and/or other) characteristics that may indicate that it is a preview (i.e., not a final rendering) that is being provided 212. For example, the previewed duplicate widgets may be displayed with dotted boundaries, with less prominence than non-preview widgets (e.g., with less brightness, in grayscale, with varying degrees of transparency, and so on), and/or in various other ways.

WD process 20 may provide 214 one or more duplicate widgets associated with a graphical widget and the identified 208 selection of the duplication region. (As used herein, the term “duplicated widget” or “original widget” may be used to refer to a widget that is duplicated by WD process 20, and the term “duplicate widget” may be used to refer to a widget created, at least in part, via WD process that is a duplicate of a duplicated widget.) The number and/or configuration of provided 214 duplicate widgets may be based upon, for example, the size and shape of the identified 208 duplication region (and/or various other settings or preferences). For example, WD process 20 may provide 214 duplicate widgets that fill, in an ordered way, an identified 208 duplication region. For example, in order to duplicate a particular widget, a user may select the widget, click-and-drag from the associated duplication handle to a different location on the relevant display, then release the mouse button. WD process 20 may accordingly, respectively, and among other functionality, identify 202 the relevant widget as active and provide 200 a depiction of a duplication handle, identify 206 the selection of the duplication region (e.g., a rectangle defined by the click-and-drag operation), and provide 214 (e.g., in response to the release of the mouse button) various duplicate widgets at locations defined by the duplication region (e.g., may provide 214 duplicate widgets in a grid (or other arrangement), the boundaries of which grid and the number of which duplicate widgets may be informed by the size and shape of the identified 208 duplication region). Similarly, for example, in certain embodiments, if selection of a rectangular duplication region is identified 208, WD process 20 may provide 214 duplicate widgets in a grid arrangement, with the size and shape of the grid defined by the size and shape of the rectangular duplication region. In this way, for example, WD process 20 may facilitate the easy duplication of a particular widget (or widgets) through the use of a duplication handle and duplication region.

In certain embodiments, a duplicate widget may include the same title, properties, and/or other aspects (e.g., shape, size, functionality, and so on) as the duplicated widget. In this way, for example, WD process 20 may facilitate exact duplication (except, for example, with respect to location) of a particular duplicated widget. In certain embodiments, a duplicate widget may include one or more variations from the title, properties, and/or other aspects of a duplicated widget. In certain embodiments, for example, WD process 20 may provide 214 duplicate widgets that vary in color, title, and/or other properties or aspects from the duplicated widget, while still retaining some of the same properties or aspects of the duplicated widget. For example, in certain embodiments, WD process 20 may provide 214 duplicate widgets that retain the same shape, size, orientation and so on as the duplicated widget, but which also include a title that varies (e.g., by sequential numbering and/or other ordered variation) with respect to the title of the duplicated widget and/or another aspect that varies from the duplicated widget (e.g., as a progressively applied color variation). For example, if a duplicated widget displays the title “Thought” and is depicted as having a bright orange body, WD process 20 may provide 214 duplicate widgets with successive titles of “Thought 1,” “Thought 2,” “Thought 3,” and so on, and with a coloring that progressively varies from the bright orange of the duplicated widget (e.g., becomes progressively more muted orange, for each successive duplicate widget).

In certain embodiments, WD process 20 may provide 214 duplicate widgets with various inter-widget spacing, orientation, and/or various other features. For example, WD process 20 may provide 216 spacing between duplicate widgets based upon, at least in part, a size factor associated with the original widget (and/or the duplicate widgets). A size factor associated with a widget may be a characteristic of one or more dimensions of the widget, such as an aspect ratio, a total area (e.g., in absolute measurement or pixels), and so on. For example, if a duplicated widget is relatively wide, as compared to its height, WD process 20 may provide 216 vertical spacing between duplicate widgets that may be smaller than if the duplicated widget were relatively narrow, as compared to its height. Similarly, for example, if a duplicated widget is relatively tall, as compared to its width, WD process 20 may provide 216 horizontal spacing between duplicate widgets that may be larger than if the duplicated widget were relatively short, as compared to its width. Similarly, for example, if a duplicated widget is relatively small in general, WD process 20 may provide 216 a horizontal and/or vertical spacing between duplicate widgets that may be larger than if the duplicated widget were less small.

It will be understood that WD process 20 may provide 216 the spacings discussed above and/or other spacing configurations alone or in various combinations, based upon, for example, various size factors associated with a duplicated (and/or duplicate) widget. For example, the various spacings discussed above may be applied in combination via the following illustrative algorithm, in which “vSpacer” denotes vertical spacing in pixels between duplicate widgets, “hSpacer” denotes horizontal spacing in pixels between duplicate widgets, “this._originalBounds.width” denotes the width in pixels of a duplicated widget, and “this._originalBounds.height” denotes the height in pixels of a duplicated widget:

// determine cell size
// if thinner then wider, position closer together
var vSpacer = 20;
var r = this._originalBounds.width /

this._originalBounds.height;

if (r>4) {

vSpacer = 5;

} else if (r>2) {

vSpacer = 10;

}
// if taller then thinner, position further apart
r = this._originalBounds.height / this._originalBounds.width;
var hSpacer = 20;
if (r>4) {

hSpacer = 100;

} else if (r>2) {

hSpacer = 60;

}
// else if smaller then a 100x100 grid; increase spacer
if (hSpacer==20 && vSpacer==20) {

if (this._originalBounds.width < 120) {

hSpacer= 120 − this._originalBounds.width;

}
if (this._originalBounds.height < 100) {

vSpacer = 100 − this._originalBounds.height;

}

}

It will be understood that, as used herein, a “duplicated widget” may refer to a single widget and/or multiple widgets that have been grouped in various ways (e.g., multiple widgets that have been grouped via a user selecting each of the widgets using a “lasso” tool). As such, for example, WD process 20 may provide 214 one or more duplicates of a single widget and/or one or more duplicates of multiple widgets, depending on the nature of the widget(s) to be duplicated (e.g., whether a single widget or multiple widgets have been selected for duplication). Similarly, for example, “duplicated widget” may refer to a widget that contains various other widgets or objects (e.g., a original widget with several other widgets or objects “nested” within it). As such, for example, WD process 20 may provide 214 one or more duplicates of an original widget, wherein the duplicate widgets may contain various other widgets, which may themselves be duplicates of the widgets contained within the original widget.

In certain embodiments, WD process 20 may facilitate duplication of widget connectors in addition/as an alternative to duplication of widgets. As also noted above, a widget connector may be a line or other representation indicating a connection between two or more widgets (and/or other graphical representations). Such a connection may indicate, for example, various relationships between connected widgets (e.g., functional dependency, association with related information, inter-widget information flow, and so on). In certain embodiments, WD process 20 may facilitate duplication of widget connectors as part of the duplication of a particular widget. For example, WD process 20 may identify 218 a widget connector associated with (e.g., connecting) a widget that is to be duplicated and a source widget. (It will be understood that the term “source” is used in this context for convenience only, to differentiate two widgets associated by widget connector, and is not intended to necessarily indicate dominance of a source widget over another widget and/or that a particular widget connector is necessarily to be viewed as “originating” at a source widget.) WD process 20 may then provide 220 one or more duplicate widget connectors associated with the source widget and one or more duplicate widgets.

For example, a user may select a widget to be duplicated that is connected by a widget connector to a source widget (which, for example, the user may not intend to duplicate at the current time). The user may select the provided 200 duplication handle and drag a mouse cursor across the relevant display (and/or provide another input) to indicate a particular duplication region, which may be identified 208 by WD process 20. Upon the user's release of the mouse button (i.e., upon the termination of the click-and-drag operation utilized to select a duplication region), WD process 20 may provide 214 various duplicate widgets within the duplication region. Based upon the duplicated widget being connected by widget connector to the source widget, WD process 20 may further provide 220 various duplicate widget connectors (i.e., widget connectors which may, respectively, connect various of the duplicate widgets to the source widget). (As used herein, the term “duplicated widget connector” or “original widget connector” may be used to refer to a widget connector that is duplicated by WD process 20, and the term “duplicate widget connector” may be used to refer to a widget connector that is a duplicate of a duplicated widget connector.) In certain embodiments, provided 220 duplicate widget connectors may include the same title, properties, and/or other aspects as the duplicated widget connector (e.g., aside from connecting the source widget to various duplicate widgets, rather than the duplicated widget). In this way, for example, WD process 20 may facilitate exact duplication of a particular duplicated widget connector (except, for example, with respect to the location of the duplicate connector and the widget to which the source widget is connected—i.e., the relevant duplicate widget). In certain embodiments, a duplicate widget connector may include one or more variations from the title, properties, and/or other aspects of a duplicated widget connector. For example, WD process 20 may configure the orientation and/or path of one or more duplicate widget connectors in order, for example, to avoid duplicate widget connectors overlapping with each other (and/or other widget connectors) and/or with various duplicated (and/or other) widgets.

In certain embodiments, WD process 20 may provide 220 duplicate widgets associated with only a portion of a particular set of duplicate widgets. This may be useful, for example, in order to prevent the provision 220 of so many duplicate widget connectors as might introduce confuse, clutter, or other issues into a particular representation or model. For example, in certain embodiments, WD process 20 may provide 214 duplicate widgets in a grid pattern. For example, in order to duplicate a particular widget that is connected by a widget connector to a particular source widget, a user may indicate a duplication region that is a rectangle (e.g., by clicking-and-dragging from a provided 200 duplication handle to a different location on the relevant display, thereby indicating diagonally opposite vertices of the rectangle). WD process 20 may accordingly provide 214 duplicate widgets in a corresponding rectangular grid arrangement. In order, for example, to reduce the visual clutter of the representation of the various duplicates, in certain embodiments WD process 20 may provide 220 duplicate widget connectors only with respect to a single row and/or single column of such a grid of duplicate widgets. For example, if the source widget is above the duplicated widget and the grid of duplicates extends to the right and downward from the duplicated widget, WD process 20 may provide 220 duplicate widget connectors with respect only to the top row and/or left column of the grid of duplicates.

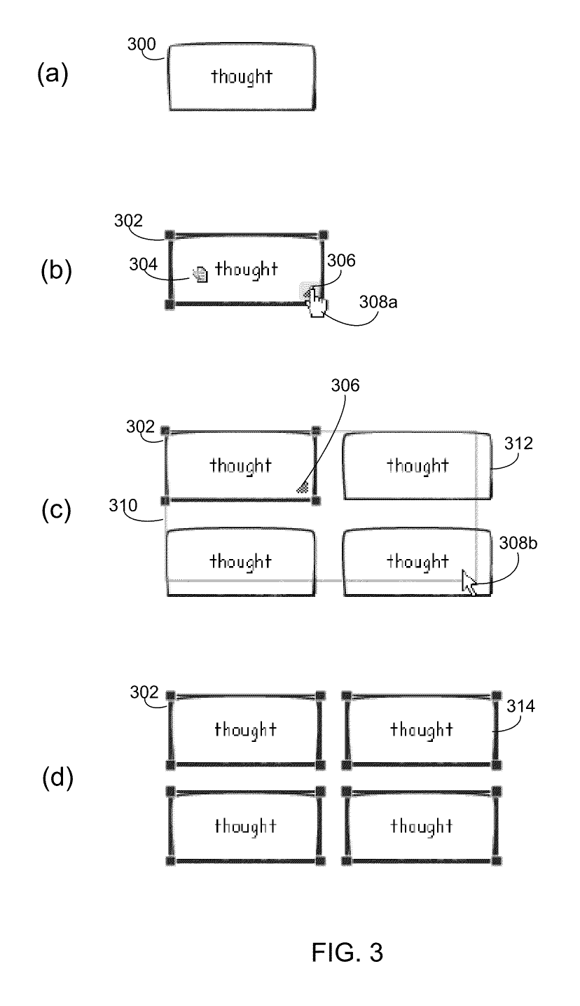

Referring now also to FIG. 3, widget 300 may be displayed by a GE application (e.g., GE application 44). A user may use a mouse (and/or other input device) to select widget 300, which may accordingly be identified 202 as an active widget by WD process 20 (e.g., as indicated by bold/heavy boundary 302 in FIG. 3(b)). The identified 202 selection of widget 300 as active may also prompt various other display changes, such as, for example, the appearance of properties icon 304 and the provided 200 depiction of duplication handle 306. A user may select duplication handle 306 using mouse cursor 308a and select a duplication region by dragging mouse cursor 308a to a different location on the relevant display. As depicted, for example, in FIG. 3(c), mouse cursor 308a may change appearance (e.g., as indicated by cursor 308b) during the selection of a duplication region. As the user selects the duplication region, WD process 20 may, for example, provide 210 depiction 310 of the duplication region (i.e., in its current size and configuration) and may provide 212 preview 312 (and other previews) of the duplicate widgets that may be provided 214 based upon the current size and configuration of the relevant duplication region (and/or other settings).

Upon identifying the finalization of the duplication region size and orientation (e.g., upon the user completing a click-and-drag operation by releasing the mouse button), WD process 20 may provide 214 various duplicate widgets (i.e., duplicates of original widget 300). For example, duplicate widget 314 may be provided 214, corresponding to provided 212 preview 312. In certain embodiments, the duplicate widgets may be provided 214 as active (and/or otherwise selected) widgets, as indicated, for example, by the bold/heavy boundary around the depicted duplicate widgets in FIG. 3(d).

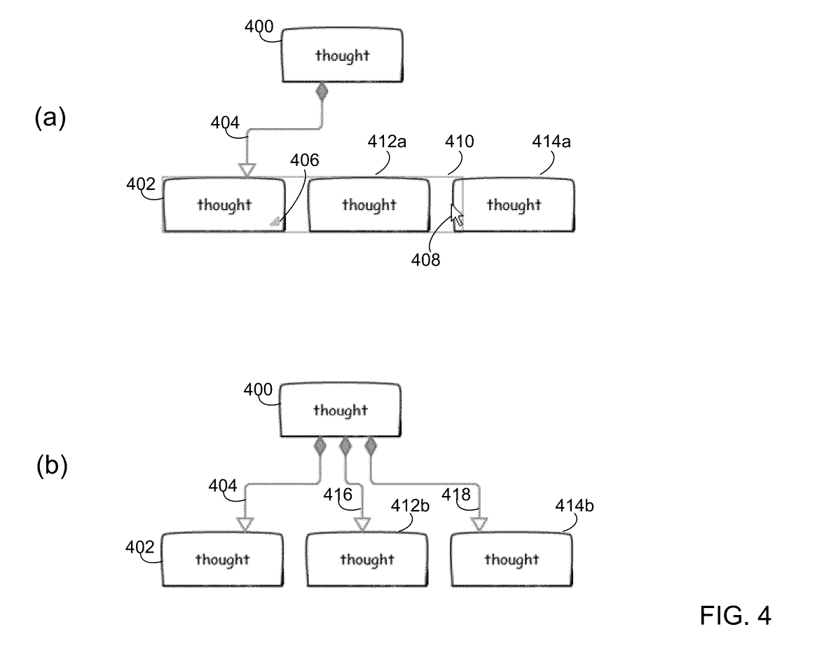

Referring now also to FIG. 4, source widget 400 may be connected by widget connector 404 to original widget 402, the display of which may include a depiction of duplication handle 406. A user may indicate the desire to duplicate original widget 402, for example, by clicking on duplication handle 406 and dragging mouse cursor 408 to the right. Accordingly, for example, WD process 20 may provide 210 depiction 410 of the current size and orientation of the associated duplication region and may similarly provide 212 previews 412a and 414a of duplicate widgets corresponding to original widget 402 and the associated duplication region. It will be understood that although preview 414a is provided 212 despite not entirely fitting within the current size and orientation of the duplication region—e.g., as indicated by depiction 410—other configurations may be possible. For example, in certain embodiments a preview of duplicate widget and/or a duplicate widget may not be provided 212, 214 unless the preview and/or actual duplicate widget completely fits within the current size and orientation of the associated duplication region (or, for example, mostly fits within the region). It will further be understood that although no preview of duplicates of widget connector 404 are provided in FIG. 4(a), other configurations may be possible. For example, WD process 20 may provide one or more previews of duplicate widget connectors in addition/as an alternative to providing 212 one or more previews of associated (or other) duplicate widgets.

Upon identifying 208 the final selection of the duplication region size and orientation (e.g., upon identifying 208 that the user has completed a relevant click-and-drag operation by releasing the mouse button), WD process 20 may provide 220 various duplicate widget connectors (i.e., duplicates of original widget connector 404) in addition to providing 214 various duplicate widgets (i.e., duplicates of original widget 402). For example, duplicate widget connectors 416 and 418 may be provided 220, connecting duplicate widgets 412b and 414b, respectively, to source widget 400.

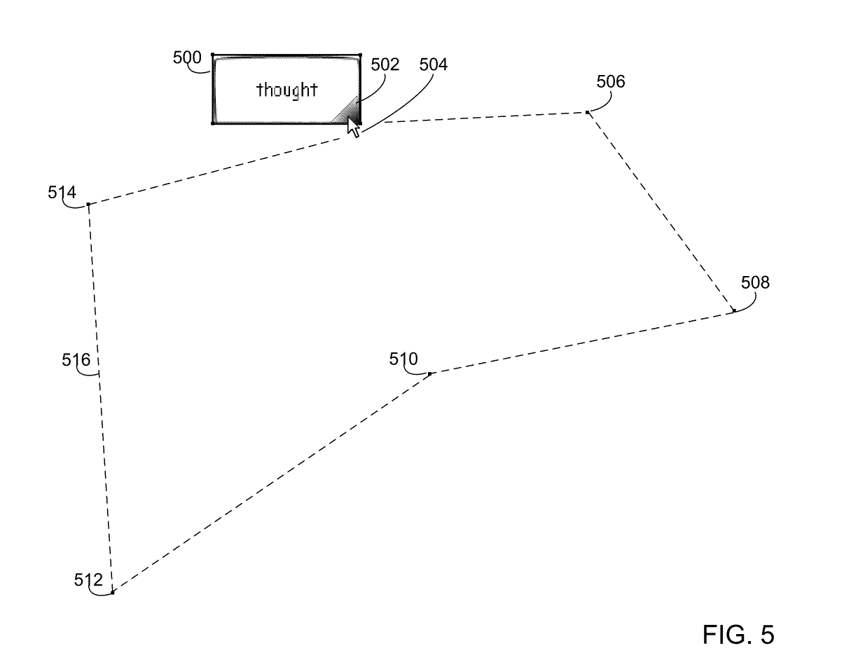

Referring now also to FIG. 5, WD process 20 may identify 208, in certain embodiments, selection of a duplication region of various shapes, sizes and/or orientations. For example, WD process 20 may identify 202 widget 500 as active (e.g., based upon a user selection) and may accordingly provide 200 a depiction of associated duplication handle 502. Based upon, for example, a user utilizing mouse cursor 504 to click, in sequence, on duplication handle 502, then vertex points 506, 508, 510, 512, and 514, WD process 20 may then identify 208 selection of duplication region 516. (A user may indicate completion of selection of such a duplication region, for example, by double-clicking on point 514, by clicking a second time on duplication handle 502, or by various other operations or actions.)

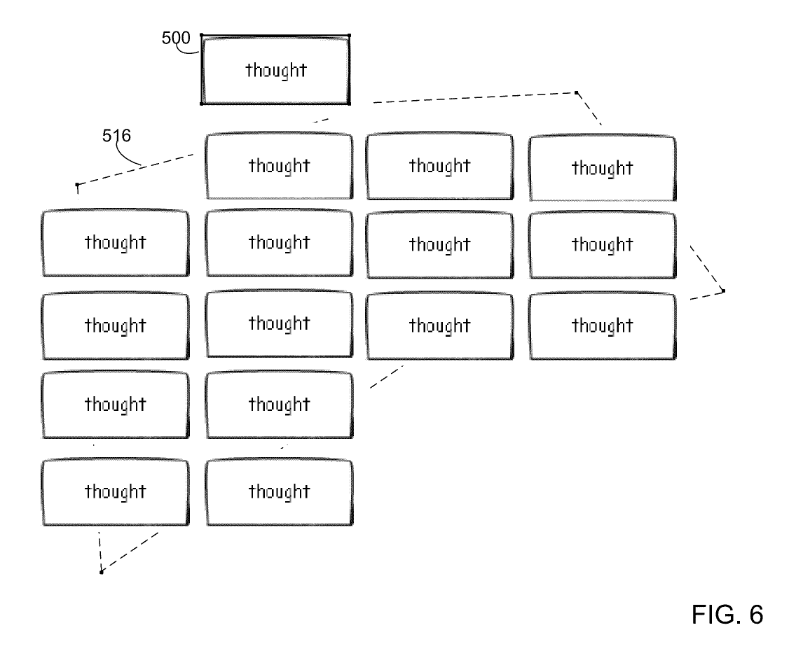

Referring now also to FIG. 6, and continuing the discussion above with respect to FIG. 5, having identified 208 selection of duplication region 516, WD process 20 may provide 214 various duplicated widgets (i.e., the various widgets contained within duplication region 516 in FIG. 6).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of embodiments and implementations have been described. Nevertheless, it will be understood that various modifications may be made. Accordingly, other embodiments and implementations are within the scope of the following claims.

What is claimed is:

1.-8. (canceled)

9. A computer program product residing on a non-transitory computer-readable storage medium having a plurality of instructions stored thereon, which, when executed by a processor, cause the processor to perform operations comprising:
providing a depiction of a duplication handle associated with a graphical widget;
identifying a selection of the duplication handle;
identifying a selection of a duplication region associated with the selection of the duplication handle; and
providing one or more duplicate widgets associated with the graphical widget and the duplication region.

10. The computer program product of claim 9 wherein the depiction of the duplication handle is provided based upon, at least in part, identifying the graphical widget as an active widget.

11. The computer program product of claim 9 wherein the duplication handle is depicted as semi-transparent.

12. The computer program product of claim 9, the operations further comprising:
providing a depiction of the duplication region based upon, at least in part, the selection of the duplication region.

13. The computer program product of claim 9, the operations further comprising:
providing a preview of the one or more duplicate widgets based upon, at least in part, the selection of the duplication region.

14. The computer program product of claim 9, the operations further comprising:
identifying a widget connector associated with the graphical widget and a source widget; and
providing one or more duplicate widget connectors associated with the one or more duplicate widgets and the source widget.

15. The computer program product of claim 14 wherein the one or more duplicate widgets are provided in a grid arrangement and the one or more duplicate widget connectors are provided only with respect to one or more of a single row of the grid and a single column of the grid.

16. The computer program product of claim 9, the operations further comprising:
providing spacing between the one or more duplicate widgets based upon, at least in part, a size factor associated with the graphical widget.

17. A computer system comprising:
one or more processor devices; and
one or more memory architectures coupled with the one or more processor devices;
wherein the one or more processor devices are configured to:
provide a depiction of a duplication handle associated with a graphical widget;
identify a selection of the duplication handle;
identify a selection of a duplication region associated with the selection of the duplication handle; and
provide one or more duplicate widgets associated with the graphical widget and the duplication region.

18. The computer system of claim 17 wherein the depiction of the duplication handle is provided based upon, at least in part, identifying the graphical widget as an active widget.

19. The computer system of claim 17 wherein the duplication handle is depicted as semi-transparent.

20. The computer system of claim 17 wherein the processor devices are further configured to:
provide a depiction of the duplication region based upon, at least in part, the selection of the duplication region.

21. The computer system of claim 17 wherein the processor devices are further configured to:
provide a preview of the one or more duplicate widgets based upon, at least in part, the selection of the duplication region.

22. The computer system of claim 17 wherein the processor devices are further configured to:
identify a widget connector associated with the graphical widget and a source widget; and
provide one or more duplicate widget connectors associated with the one or more duplicate widgets and the source widget

23. The computer system of claim 22 wherein the one or more duplicate widgets are provided in a grid arrangement and the one or more duplicate widget connectors are provided only with respect to one or more of a single row of the grid and a single column of the grid.

24. The computer system of claim 17 wherein the processor devices are further configured to:
provide spacing between the one or more duplicate widgets based upon, at least in part, a size factor associated with the graphical widget.

25. (canceled)
